(19) United States
(12) Patent Application Publication
(10) Pub. No.: US 2012/0116739 A1
(43) Pub. Date: May 10, 2012

(54) Infrared Microspectroscopy for Intact Fibers

(75) Inventors: Brynmor J. Davis, Etna, NH (US); Paul Scott Carney, Champaign, IL (US); Rohit Bhargava, Urbana, IL (US)

(73) Assignee: The Board of Trustees of the University of Illinois, Urbana, IL (US)

(21) Appl. No.: 12/941,159

(22) Filed: Nov. 8, 2010

(51) Int. Cl. G06G 7/48; G01J 3/28; G06F 19/00

(52) U.S. Cl. 703/6; 702/155; 356/326

(57) ABSTRACT

Methods and a non-transient computer medium embodying computer readable code for extracting bulk spectroscopic properties of a particle. A forward model is built of an optical field focused on, and interacting with, the particle, where the forward model parameterized in terms of at least one geometrical characteristic of the particle. The particle, which may be a filamentary material, is illuminated with an incident optical field having a spectral range. Either a transmitted or scattered optical field is detected in a far-field zone as a function of wavenumber to obtain a measured spectrum. The measured spectrum is inverted to recover the imaginary part of the complex refractive index of the particle.

This invention was made with Government support under Grant CHE0957849 awarded by the National Science Foundation. The Government has certain rights in the invention.

### TECHNICAL FIELD OF THE INVENTION

The present invention pertains to methods and apparatus for identifying a chemical constituent of a particle characterized by geometrical features that are comparable to the wavelength of light used to interrogate the particle, and, more particularly, to methods for accounting for geometrical characteristics in retrieving a bulk spectrum of the constituents of the particle.

### BACKGROUND OF THE INVENTION

Infrared (IR) vibrational spectroscopy has been used extensively in the molecular analysis of fibers, hair, and for composites with fiber-type inclusions. Such applications of IR spectroscopy are described in various references such as the following, all of which are incorporated herein by reference:
O'Connor et al., Textile Research J., 1958, pp. 382-92 (1958);
Murthy et al., Polymer, 36, pp. 3863-73 (1995);
Felix et al., J. Appl. Polymer Sci., 42, pp. 609-20 (1991);
Ishida et al., Polymer Eng. & Sci., 18, pp. 128-45 (1978);
Bhargava et al., Adv. Polym. Sci., 163, pp. 137-91 (2003); and
Compton et al., Am. Lab., 23, pp. 41-51 (1991).

For synthetic fibers, IR spectra provide molecular, microstructural and orientation measurements used in predicting the mechanical properties of the sample. Since these properties of the fiber determine its suitability for specific applications, the accuracy of spectroscopic measurements is critical. Accurate spectral information is also critical for the analysis of fiber-type samples of forensic interest, for example synthetic and natural fibers as well as hair. A rapid and convenient method to characterize these samples is infrared (IR) absorption spectroscopy in which the vibrational spectrum of a material can potentially be used to determine the above properties of interest. Given the small size of individual fibers, a microspectrometric measurement is typically conducted, as described by Levin et al., Ann. Rev. Phys. Chem., 56, pp. 429-74 (2005), which is incorporated herein by reference.

It is known that direct recording of spectral data from fibers leads to extensive distortions in the spectra as compared to the intrinsic material response. The sample refracts light, acting as a lens, and also scatters light, thereby complicating the otherwise simple equivalence of the geometrical parameters of the sample and effective path length to be used for quantitative analysis in Beers law. More importantly, the diameter of fibers is often of the same order of magnitude as the wavelength of light in the mid-IR. Hence, wavelength-dependent scattering at the sample boundary imparts a molecularly nonspecific attenuation that complicates interpretation of the data. The effect of these spectral distortions can be gauged in contrasting the rather limited progress in IR spectroscopic analysis of fibrous materials with that achieved, in both theory and practice, using Raman microspectroscopic analysis. To overcome spectral distortions and enable IR spectral analyses, the use of alternatives such as microtoming, solution casting, sample flattening, the use of a diamond anvil cell or the use of other spectroscopic techniques is typically prescribed. These methods, however, are suboptimal as they often destroy some structure of the fibers that may be useful for forensic analysis or for relating fiber structures to their properties.

A rigorous optical theory for infrared microspectroscopy has recently been developed in which a framework is presented that relates the recorded spectroscopic imaging data to the experimental setup and sample properties. This theory is described in Davis et al., “Theory of Midinfrared Absorption Microspectroscopy: I. Homogeneous Samples,” Anal. Chem., 82, pp. 3474-86 (2010) (hereinafter, “Davis (2010)”), and Davis et al., “Theory of Mid-infrared Absorption Microspectroscopy: II. Heterogeneous Samples,” Anal. Chem., 82, pp. 3487-99 (2010) (hereinafter, “Davis (2010a)”), both of which are incorporated herein by reference. Theoretical predictions and experimental validation demonstrated that spectral distortions could be modeled for simple geometries such as layered samples or simple edges.

### SUMMARY OF EMBODIMENTS OF THE INVENTION

In accordance with preferred embodiments of the present invention, a method is provided for extracting bulk spectroscopic properties of a particle, where the particle is characterized by a complex refractive index, i.e., a refractive index with a real and an imaginary part. The method has steps of:
a. building a forward model of an optical field focused on, and interacting with, the particle, the forward model parameterized in terms of at least one geometrical characteristic of the particle;
b. illuminating the particle with an incident optical field having a spectral range;
c. detecting a transmitted or scattered optical field in a far-field zone as a function of wavenumber to obtain a measured spectrum;
d. inverting the measured spectrum to recover the imaginary part of the complex refractive index of the particle.

In accordance with other embodiments of the invention, the particle may include a filament, a sphere, an oblate or prolate spheroid, or any other shape. In the case of a filamentary particle, the forward model may be parameterized in terms of a radius associated with the filament.

In accordance with further embodiments of the invention, the step of inverting the measured spectrum may include:
a. assuming an initial real index;
b. calculating an absorption spectrum;
c. evaluating a difference between the calculated absorption spectrum and the measured spectrum;
d. applying the Kramers-Kronig relation to obtain an updated real index; and
e. iterating steps (b.) through (d.) to convergence.

In accordance with yet further embodiments of the present invention, a non-transitory computer readable medium is provided for use on a computer system for extracting bulk spectroscopic properties of a filamentary material. The non-transitory computer readable medium has computer-readable program code on it, and, more particularly:
a. a computer code module for building a forward model of an optical field focused on, and interacting with, the filamentary material, the forward model parameterized in terms of at least one geometrical characteristic of the filamentary material;
b. a computer code module for receiving a detector signal as a function of wavenumber to obtain a measured spectrum; and
d. a computer code module for inverting the measured spectrum to recover the imaginary part of the complex refractive index of the filamentary material.

### DESCRIPTION OF THE FIGURES

The foregoing features of the invention will be more readily understood by reference to the following detailed description, taken with reference to the accompanying drawings, in which:

FIG. 1 is a schematic depiction of a fiber, indicating the coordinates used in the present description;

FIG. 2 illustrates the fields in and around a fiber when it is illuminated (from left to right) by a field focused to the center of the fiber by Cassegrain: (a) the real part of the complex field U (θ, ρ, γ, ν̅); (b) the optical intensity of the field, i.e., |U (θ, ρ, γ, ν̅)|²; (c) the real part of the complex field incident from the focusing Cassegrain Uᵢ (θ, ρ, γ, ν̅); (d) the real part of the scattered field Uₛ (θ, ρ, γ, ν̅). In each case the x-z plane through the geometric focus is shown. The fiber (boundary indicated by the dashed blue line) has a radius of one wavelength and a refractive index of 1.45+i0.025. The numerical aperture of the Cassegrain is 0.4 and the numerical aperture of the obscuration is 0.1.

FIG. 3 is a plot of the complex refractive index of toluene.

FIG. 4 shows data predicted for toluene fibers of radii 5 μm and 10 μm, and for an ideal sample, of thickness d=10 μm, exhibiting no optical artifacts. (a) The transmission fraction I_{S}( ν̅)/I₀( ν̅). (b) The absorbance A( ν̅=−log₁₀ [I_{S}( ν̅)/I₀( ν̅)]. For the ideal sample the absorbance is related to the imaginary refractive index by A( ν̅)=4π ν̅k( ν̅)d/log₁₀^{e}, while for the fibers the model presented here describes the more complicated relationship between the physical parameters of the fiber and the data.

FIG. 5 shows data predicted for fibers of (a) radius 5 μm and (b) radius 10 μm. Three fiber refractive indices are considered—a constant real index of n=1.45, the complex index of toluene, and a constant real index found via a best fit procedure to the toluene data in the wavenumber range marked in green (2100 cm⁻¹-2600 cm⁻¹). The constant indices n₀ are 1.477 for the 5 μm-radius fiber and 1.478 for the 10 μm-radius fiber.

FIG. 6 is a flowchart depicting general steps in accordance with methods of preferred embodiments of the present invention.

FIG. 7 is a flowchart depicting steps in accordance with methods for performing an inversion to derive spectral properties in accordance with embodiments of the present invention.

FIGS. 8(a)-8(f) plots reconstructions and true values of the complex refractive index and the corresponding predicted data, in accordance with embodiments of the present invention. Fibers of radius 5 μm (a-c) and 10 μm (d-f) are considered. The transmission percentage is illustrated (a,d), along with the imaginary (b,e) and real (c,f) parts of the refractive index. The reconstructions shown were produced after nine iterations of the algorithm.

FIGS. 9(a)-9(f) plots differences between the estimated quantities, in accordance with embodiments of the present invention, and the true values as a function of iteration number. Data for fibers of radius 5 μm (a-c) and 10 μm (d-f) are shown. Differences are calculated for the transmission fraction (a,d), and the imaginary (b,e) and real (c,f) parts of the refractive index.

### DESCRIPTION OF SPECIFIC EMBODIMENTS OF THE INVENTION

Definitions. Unless the context requires otherwise, the term “particle” as used herein, and in any appended claims, shall denote matter configured such that one dimension characterizing the matter is comparable in size to a characteristic wavelength of light (or other radiation) used to interrogate its properties. Thus, for example, the first dimension may correspond to characteristic radius of a sample. A particle may be substantially spherical (having all characteristic dimensions comparable to the wavelengths used to measure properties of the particle and roughly equal to each other. Alternatively, the particle may be oblate or prolate where orthogonal dimensions may be unequal. The particle may also have a dimension that substantially exceeds the length scale of interrogating wavelengths, as in the case of a filament or fiber, for example.

Unless the context requires otherwise, the terms “filament” and “fiber” as used herein, and in any appended claims, shall denote matter configured such that one dimension characterizing the matter is comparable in size to the wave-length of light (or other radiation) used to interrogate its properties, while another dimension is appreciably larger than the first dimension, typically, at least four times as large. Thus, for example, the first dimension may correspond to characteristic radius of the fiber, while the second dimension may correspond to the axial length of the fiber. Adjectival forms such as “filamentary” and “fibrous” are to understood accordingly. Characterization of materials that incorporate fibers, as in a matrix of plastic or glass, for example, are within the scope of the present invention.

In the present description and in any appended claims, the word “approximate” will be used functionally, i.e., it denotes a degree required to meet discrimination criteria appropriate for a specified application.

In accordance with embodiments of the present invention, the theory of infrared microspectroscopy is extended to particles and to cylindrical objects, in particular, to understand spectral distortions in fibers. Correction of distortions using the developed theoretical treatment may advantageously enable truly nonperturbing IR microspectroscopic analysis. While polarization and dichroic or trichroic ratio measurements are not expressly addressed, and while discussion is limited, for heuristic simplicity, to isotropic fibers, it is to be understood that the developed framework, as described herein, may be extended to extract these measures of orientation as well, within the scope of the present invention.

First, classical optical theory is used to describe the interaction of focused light with a fiber with known radius and optical properties. It is to be understood that, while the treatment herein applies to fibers and is developed in terms of cylindrical symmetry, the methods illustrated herein with reference to fibers may be applied, as well, to particles of any shape, such as spheres, or oblate or prolate spheroids, where similar analytical methods may be applied, and, also, for particles or any specified geometry, using numerical methods.

For simplicity of exposition, scalar optical fields are used in this analysis but it should be understood that the methods described herein may be readily generalized to vector fields. Similarly, while a homogeneous fiber is considered, the methods described herein may be generalized, in a straightforward manner, to en-compass multi-core fibers, i.e., fibers consisting of concentric cylinders of different materials.

The forward model allows the prediction of measurements given a fiber with a material of known spectral properties and geometry. However, the goal of this work is to provide a means of determining the optical material properties from measurements. To do this an inverse problem must be solved—that is, given measurements, material properties are determined using the physical understanding of the system quantified by the forward model. Finally, a means of solving the inverse problem and an algorithmic implementation are described.

To understand the relationship between the collected data and the optical properties of the fiber material, it is necessary to understand the interaction of the optical fields in the measurement system with the fiber. The geometry of this system is illustrated in FIG. 1. The field incident on the fiber, the field in the fiber and the field scattered from the fiber are now described. Using these fields, measurements can be predicted for a known fiber. This model is based on classical electromagnetic theory and an appropriate detection model discussed in Davis (2010a). Light, or any other form of electromagnetic radiation, is focused on to a fiber of fixed radius with the goal of obtaining measurements that can be used to determine the optical properties of the fiber material. The analysis used to describe this system employs both Cartesian and cylindrical coordinates, as shown. The axis of the fiber is chosen to lie along the y axis of both coordinate systems. The distance from the origin, r=\sqrt{x²+y²+z²}=\sqrt{ρ²+y²}, also appears in the resulting expressions.

General Form of the Optical Field

There are two regions of homogeneous material in this problem. It is convenient to represent the total field U differently in each region, i.e.,

$$U ( θ , ρ , y , \overline{v} ) = \{ \begin{matrix}{U}_{0} ( θ , ρ , y , \overline{v} ) = {U}_{i} ( θ , ρ , y , \overline{v} ) + {U}_{s} ( θ , ρ , y , \overline{v} ) & ρ > R \\ {U}_{1} ( θ , ρ , y , \overline{v} ) & ρ \leq R\end{matrix} , \qquad ( 1 )$$

where R is the radius of the fiber and ν̅ is the wavenumber (the reciprocal of the wavelength). Here U₀ describes the field outside the fiber, while U₁ describes the internal field. Further, the external field is the superposition of Uᵢ, the field used to illuminate the fiber, and Uₛ, the field scattered from the fiber.

The optical properties of each region are determined by a complex refractive index. The region outside the fiber is assumed to be air, with a refractive index well approximated as unity. The fiber has a complex refractive index n( ν̅)+ik( ν̅), with the imaginary part k( ν̅) determining absorption properties. The fields in the system are found by using well-known representations of fields in homogeneous materials and ensuring that boundary conditions are satisfied at the interface of the fiber and the surrounding air.

Optical Fields in Cylindrical Coordinates

As illustrated in FIG. 1, the symmetry of the fiber suggests an analysis in cylindrical coordinates. For this reason, all relevant optical fields will be represented in (θ, ρ, γ) coordinates and converted to Cartesian coordinates where required. In cylindrical coordinates, fields in a homogeneous medium can be written in terms of the modal expansion:

$${U}_{h} ( θ , ρ , y , \overline{v} ) = {\sum }_{m = - ∞}^{∞} \int d {s}_{y} {G}_{h} ( m , {s}_{y} , \overline{v} ) {e}^{i m θ} \times {Z}_{m} \{ 2 π \overline{v} ρ \sqrt{{[ n ( \overline{v} ) + ik ( \overline{v} ) ]}^{2} - {s}_{y}^{2}} \} exp ( i 2 π \overline{v} {s}_{y} y ) , \qquad ( 2 )$$

based on the solutions to the wave equation found via separation of variables. Here Zₘ is a Bessel function of order m and can represent either Bessel functions of the first kind, Jₘ, Bessel functions of the second kind, Yₘ. The function Gₕ(m, s_{y}, ν̅) represents coefficients of the cylindrical Bessel modes and can be thought of as a spectral representation of the homogeneous-material field Uₕ(θ, ρ, γ, ν̅). In Eq. (1), the general refractive index n( ν̅)+ik( ν̅) appears in the argument of the Bessel function. In air, this quantity is replaced by 1.

The Illuminating Field

The fiber is illuminated by light from a focusing system, typically a Cassegrain reflector. In this treatment, the optical axis of the focusing system is assumed to be perpendicular to the fiber and is assigned to the z axis. A focused field is most typically described in Cartesian coordinates as Ũ(x, y, z, ν̅), where a tilde will be used to denote a function on Cartesian axes.

The focused field is conveniently described using an angular spectrum of planewaves.

$${\tilde{U}}_{i} ( x , y , z , \overline{v} ) = i \overline{v} \int \int d {s}_{x} d {s}_{y} \frac{{\tilde{B}}_{i} ( {s}_{x} , {s}_{y} , \overline{v} )}{{s}_{z}} exp [ i 2 π \overline{v} ( {s}_{x} x + {s}_{y} y + {s}_{z} z ) ] , \qquad ( 3 )$$

where

s_{z}=\sqrt{1−sₓ²−s_{y}²}. (4)

Here the unit vector (sₓ, s_{y}, s_{z}) gives the direction of propagation of each planewave component and \tilde{B}ᵢ(sₓ, s_{y}, ν̅) is the planewave angular spectrum of the illuminating field.

The modal expansion of Eq. (3) is defined such that the field at distance r from the origin is \tilde{B}ᵢ(x/r, y/r, ν̅)e^{i2π ν̅r}/r for positive values of z and −\tilde{B}ᵢ(x/r, y/r, ν̅)e^{i2π ν̅r}/r for negative values z. The field on the hemisphere of the illuminating aperture (which lies in the −z half space) is therefore proportional to the angular spectrum of the illuminating field. In this scalar treatment, the field across the illuminating aperture is taken to be constant so that

$${\tilde{B}}_{i} ( {s}_{x} , {s}_{y} , \overline{v} ) = \{ \begin{matrix}1 & {Γ}_{1} \geq \sqrt{{s}_{x}^{2} + {s}_{y}^{2}} \geq {Γ}_{2} \\ 0 & else ,\end{matrix} \qquad ( 5 )$$

where Γ₂ is the numerical aperture of the Cassegrain and Γ₁ is the numerical aperture of the central Cassegrain obstruction.

To represent the illuminating field in cylindrical coordinates, a coordinate transformation (x, y, z) [symbol] (ρ, θ, y) is made, resulting in the following transformation of the unit propagation vector

sₓ=\sqrt{1−s_{y}²}sin s_{θ}, (6)

s_{y}=s_{y}, (7)

s_{z}=\sqrt{1−s_{y}²}cos s_{θ}. (8)

The Cartesian angular spectrum representation of Eq. (3) then becomes

Uᵢ(θ,ρ,y, ν̅)=i ν̅∫∫ds_{θ}ds_{y}Bᵢ(s_{θ},s_{y}, ν̅)exp {i2π ν̅[ρ\sqrt{1−s_{y}²}cos(θ−s_{θ})+s_{y}y]}. (9)

To put this equation in the form of Eq. (1), the Jacobi-Anger expansion is employed:

$$exp ( i2π \overline{v} ρ \sqrt{1 - {s}_{y}^{2}} cos θ ) = {\sum }_{m = - ∞}^{∞} {i}^{m} {e}^{i m θ} {J}_{m} ( 2 π \overline{v} ρ \sqrt{1 - {s}_{y}^{2}} ) . \qquad ( 10 )$$

The illuminating field can be written in the form of Eq. (1) by substituting Eq. (1) into Eq. (9),

$$\begin{matrix}{U}_{i} ( θ , ρ , y , \overline{v} ) = i \overline{v} {\sum }_{m = - ∞}^{∞} \int \int d {s}_{y} d {s}_{θ} {B}_{i} ( {s}_{θ} , {s}_{y} , \overline{v} ) {e}^{- i {ms}_{θ}} {i}^{m} {e}^{i m θ} \times \\ {J}_{m} ( 2 π \overline{v} ρ \sqrt{1 - {s}_{y}^{2}} ) exp ( i 2 π \overline{v} {s}_{y} y ) , \\ = {\sum }_{m = - ∞}^{∞} \int d {s}_{y} {G}_{i} ( m , {s}_{y} , \overline{v} ) {e}^{i m θ} {J}_{m} ( 2 π \overline{v} ρ \sqrt{1 - {s}_{y}^{2}} ) \times \\ exp ( i 2 π \overline{v} {s}_{y} y ) ,\end{matrix} \qquad ( 11 )$$

with

Gᵢ(m,s_{y}, ν̅)=i^{m+1} ν̅∫ds_{θ}Bᵢ(s_{θ},s_{y}, ν̅)e^{-ims}^{_{θ.}} (12)

Note that the expression above is closely related to the Fourier series of Bᵢ(s_{θ}, s_{y}, ν̅) over s_{θ}.

The Scattered and Internal Fields

The field inside the fiber can be expressed as in Eq. (1). In this case,

$${U}_{1} ( θ , ρ , y , \overline{v} ) = {\sum }_{m = - ∞}^{∞} \int d {s}_{y} {G}_{1} ( m , {s}_{y} , \overline{v} ) {e}^{i m θ} \times {J}_{m} \{ 2 π \overline{v} ρ \sqrt{{[ n ( \overline{v} ) + i k ( \overline{v} ) ]}^{2} - {s}_{y}^{2}} \} exp ( i 2 π \overline{v} {s}_{y} y ) . \qquad ( 13 )$$

Here Bessel functions of the second kind, Yₘ, are not included in the representation, as these functions are infinite at the origin and thus are nonphysical.

Similarly, the scattered field can be written as,

$${U}_{s} ( θ , ρ , y , \overline{v} ) = {\sum }_{m = - ∞}^{∞} \int d {s}_{y} {G}_{s} ( m , {s}_{y} , \overline{v} ) {e}^{i m θ} \times {H}_{m} ( 2 π \overline{v} ρ \sqrt{1 - {s}_{y}^{2}} ) exp ( i 2 π \overline{v} {s}_{y} y ) . \qquad ( 14 )$$

Here Hₘ is a Hankel function of the first kind, i.e., Hₘ(l)=Jₘ(l)+iYₘ(l). This choice of Bessel function is made because Hankel functions represent strictly out-going waves, a condition required for the scattered field. Also note that the refractive index appearing in the argument of the Hankel function is unity, as the scattered field is in free space.

Solving for the Fields

It can be seen from Eqs. (10-12) that the illumination, internal and scattered fields can all be represented as a superposition of modal fields indexed by m and s_{y}. Each scattered mode and each internal mode is a solution of the wave equation and must be linearly related to the corresponding illumination mode. Consequently,

Gₛ(m,s_{y}, ν̅)=Gᵢ(m,s_{y}, ν̅)a(m,s_{y}, ν̅), (15)

Gₗ(m,s_{y}, ν̅)=Gᵢ(m,s_{y}, ν̅)b(m,s_{y}, ν̅). (16)

Additionally, the superposition of the illuminating, scattered and internal fields must be continuous and have a continuous first derivative. Therefore by considering the fields at the fiber boundary, ρ=R, the relationship between the illuminating field and the scattered and internal fields can be determined.

$$\begin{matrix}a ( m , {s}_{y} , \overline{v} ) = \frac{\sqrt{{[ n \{ \overline{v} ) + i k ( \overline{v} ) ]}^{2} - {s}_{y}^{2}} {J}_{m} ( {l}_{0} ) {J}_{m}^{′} ( {l}_{1} ) - \sqrt{1 - {s}_{y}^{2}} {J}_{m} ( {l}_{1} ) {J}_{m}^{′} ( {l}_{0} )}{\sqrt{1 - {s}_{y}^{2}} {J}_{m} ( {l}_{1} ) {H}_{m}^{′} ( {l}_{0} ) - \sqrt{{[ n ( \overline{v} ) + i k ( \overline{v} ) ]}^{2} - {s}_{y}^{2}} {H}_{m} ( {l}_{0} ) {J}_{m}^{′} ( {l}_{1} )} , & ( 17 ) \\ b ( m , {s}_{y} , \overline{v} ) = \frac{\sqrt{1 - {s}_{y}^{2}} {J}_{m} ( {l}_{0 } ) {H}_{m}^{′} ( {l}_{0} ) - \sqrt{1 - {s}_{y}^{2}} {H}_{m} ( {l}_{0} ) {J}_{m}^{′} ( {l}_{0} )}{\sqrt{1 - {s}_{y}^{2}} {J}_{m} ( {l}_{1} ) {H}_{m}^{′} ( {l}_{0} ) - \sqrt{{[ n ( \overline{v} ) + i k ( \overline{v} ) ]}^{2} - {s}_{y}^{2}} {H}_{m} ( {l}_{0} ) {J}_{m}^{′} ( {l}_{1} )} , & ( 18 ) \\ where {l}_{0} = 2 π \overline{v} R \sqrt{1 - {s}_{y}^{2}} and {l}_{1} = 2 π \overline{v} R \sqrt{{[ n ( \overline{v} ) + i k ( \overline{v} ) ]}^{2} - {s}_{y}^{2}} . & \end{matrix}$$

The derivatives of the Bessel functions can be calculated using the property

$${Z}_{m}^{′} ( l ) = \frac{m}{l} {Z}_{m} ( l ) - {Z}_{m + 1} ( l ) .$$

It can also be seen that a (m, s_{y}, ν̅)=a(−m, s_{y}, ν̅) and b(m, s_{y}, ν̅)=b(−m, s_{y}, ν̅), as Z₋ₘ(l)=(−1)^{m}Zₘ(l).

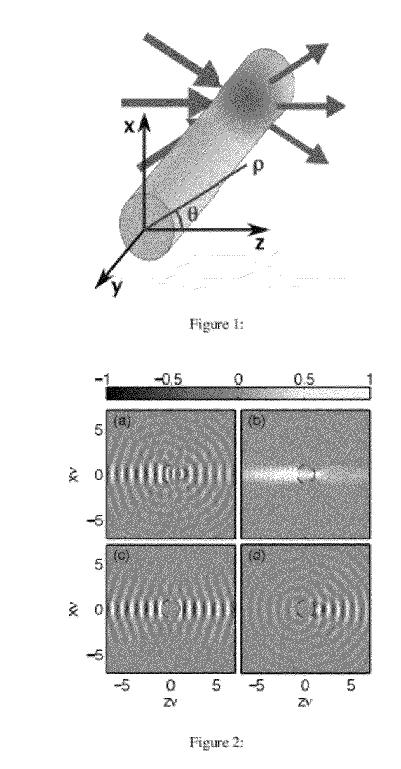

The results above provide a means to calculate the fields resulting from the focused illumination of a fiber. An example is shown in FIG. 2. It can be seen that the calculated fields sum to give a continuous field distribution. The scattered field (d) is concentrated in the forward scattering direction. This scattered field has the effect of canceling some of the field that would be observed without the presence of the fiber (c). Physically, this cancellation accounts for the light extinguished by the fiber.

Scattered Light in the Far-Field

The physical properties of the fiber are encoded in the scattered field, which is described by Eqs. (9), (15), and (17). The integrand seen in Eq. (9) becomes highly oscillatory for large values of ν̅ ρ, i.e., as the field is evaluated a large number of wavelengths from the fiber. Thus asymptotic evaluation of Eq. (9) at the detection optics is sensible and is accomplished using the large-argument form of the Hankel function.

$${H}_{m} ( l ) \sim {( - i )}^{m} \sqrt{\frac{2}{iπ l}} exp ( i l ) .$$

Applying the Fourier series convolution theorem gives a highly oscillatory complex exponential in the inte-grand that can be evaluated using the principle of stationary phase. The resulting expression for the scattered field many wavelengths from the fiber is

$$\begin{matrix}{lim}_{r -> ∞} {U}_{s} ( θ , ρ , y , \overline{v} ) = \int d {s}_{θ} {B}_{i} ( {s}_{θ} , \frac{y}{r} , \overline{v} ) α ( θ - {s}_{θ} , \frac{y}{r} , \overline{v} ) \frac{{e}^{i 2 π \overline{v} r}}{r} , \\ where & ( 19 ) \\ α ( {s}_{θ} , {s}_{y} , \overline{v} ) = \frac{1}{π} {\sum }_{m = - ∞}^{∞} a ( m , {s}_{y} , v ) {e}^{i m θ} . & ( 20 )\end{matrix}$$

This expression is readily evaluated by numerical methods.

### The Detected Signal

An optical detection system is typically positioned in the far field of the z≧0 half space, where, as discussed above, the illuminating field is Bᵢ(θ, y/r, ν̅) exp(i2π ν̅r)/r in this region. Consequently, the total field in the far field of the z≧0 half space is asymptotically, for large values of ν̅r

$$U ( θ , ρ , y , \overline{v} ) \sim [ {B}_{i} ( θ , \frac{y}{r} , \overline{v} ) + \int d {s}_{θ} {B}_{i} ( {s}_{θ} , \frac{y}{r} , \overline{v} ) α ( θ - {s}_{θ} , \frac{y}{r} , \overline{v} ) ] \frac{{e}^{i2π \overline{v} r}}{r} . \qquad ( 21 )$$

While the calculation of fields over all space has been described, if one is interested only in the field many wavelengths from the fiber it is necessary only: to define the illuminating field (e.g., by Eq. (5), the diameter of the fiber and the refractive index; to calculate the coefficients a(m, s_{y}, ν̅) by Eq. (12); to evaluate α(s_{θ}, s_{y}, ν̅) via Eq. (20); and to evaluate Eq. (21) to get the resulting far-field amplitude distribution.

The detection optics accept light over some entrance aperture surface S and the spectrometer resolves the wavenumber ν̅. In general, the field on the detection aperture must be mapped to the detector to determine the measured optical intensity. However, many common optical detection arrangements are well-approximated by modeling the detection process as an integration of the optical intensity over the detection aperture, as discussed by Davis (2010a). The detected intensity is then

I( ν̅)=ƒ|U(θ,ρ,y, ν̅|²dS. (22)

For heuristic convenience, it will be assumed that the detection optics consist of a detection Cassegrain opposing the illumination Cassegrain. Within the scope of the present invention, the manner in which the particle-illuminating beam is focused is accounted for in the forward model. The Cassegrain pair are matched in both focal point and aperture extent. In the present example, it is also assumed that the common focal point of the Cassegrains lies at the center of the fiber.

A background measurement I₀( ν̅) is typically taken with no sample present between the Cassegrains. This signal depends both on the spectrum of the source and the optical characteristics of the measurement system. The measurement taken with the sample present will be denoted by I_{S}( ν̅). Ideally, the recorded absorbance is related to the absorption of the sample by,

$$\begin{matrix}A ( \overline{v} ) = - {log}_{10} [ \frac{{I}_{S} ( \overline{v} )}{{I}_{0} ( \overline{v} )} ] , \\ = \frac{4 π \overline{v} k ( \overline{v} ) d}{{log}_{e} ( 10 )} ,\end{matrix}$$

where d is the thickness of the sample. However, even for relatively simple planar samples, this approach can be subject to significant errors due to diffraction, scattering and other optical effects.

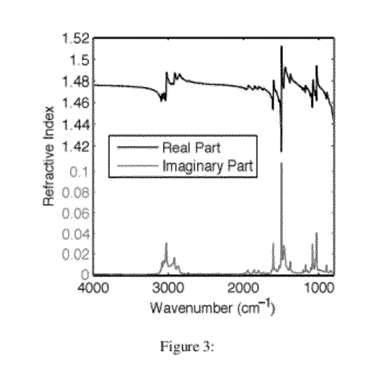

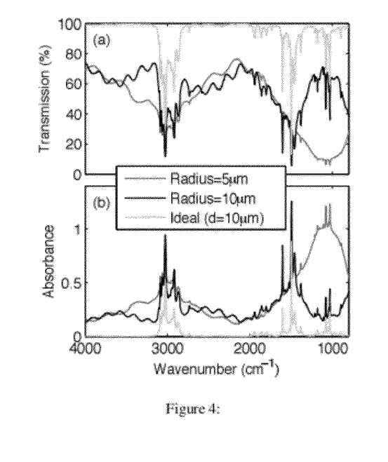

The problems introduced by diffraction are even more significant in fiber measurement, where fiber radii are often of the order of the wavelength, leading to significant scattering artifacts. As an example, data are predicted for hypothetical cylinders made from toluene. Toluene has a well characterized complex refractive index as shown in FIG. 3, which allows a rigorous prediction of the measurement. While a fiber of toluene is physically unrealistic, use of the same material provides a basis for comparison between the spectral responses from uniform films discussed in the prior literature and cylindrical objects. The transmittance I_{S}( ν̅)/I₀( ν̅), and the corresponding absorbance values, calculated from the first line of Eq. (22), are plotted in FIG. 4. Significant differences can be seen between the data predicted for the different physical arrangements.

As seen in FIG. 4, the imaginary part of the refractive index, i.e., the spectral absorption profile of the fiber material, strongly influences the data. However, phenomena other than absorption also affect the data. Scattering directs light away from the detection optics in a manner that depends both on the real part of the refractive index n( ν̅) and the radius of the fiber. The standard model presented in the second line of Eq. (22) is too simple to provide a quantitative understanding of the data. To measure the chemical absorption spectrum of the fiber material, it is necessary to use a rigorous physical model to extract the desired quantity, the imaginary part of the refractive index. The remainder of this manuscript describes a method for finding the imaginary index k( ν̅) from measured data.

The Inverse Problem

A rigorous model has been described above for the interaction between the fiber and the focused probing light, i.e., the measured spectrum can be predicted given a description of the fiber. This forward model must be inverted in order to re-cover the physical and true spectral properties of the fiber from the measurements. This inverse problem is solved by finding the fiber properties that best explain the measurements.

It is assumed, for heuristic purposes, that the fiber radius R can be independently measured, leaving the complex refractive index as the only unknown property of the fiber. Recovering the imaginary part of the index k( ν̅) is the primary goal, as a corrected absorbance profile can be calculated (see the second line of Eq. (22) from k( ν̅), i.e., an absorbance function corrected for optical effects such as scattering. However, the real part of the refractive index n( ν̅) will also be determined as part of the solution to the inverse problem.

Finding the Constant Part of the Real Index

The real part of the refractive index necessarily varies in spectral regions exhibiting absorption, as quantified by the Kramers-Kronig relation. However, in spectral regions exhibiting no absorption, the real index can be expected to be approximately constant. In the inversion procedure described here, a characteristic constant offset for the refractive index is assumed across the measurement band-width. This constant value, n₀, can be loosely regarded as the refractive index of the fiber absent any changes in the index produced by absorption peaks of the fiber material.

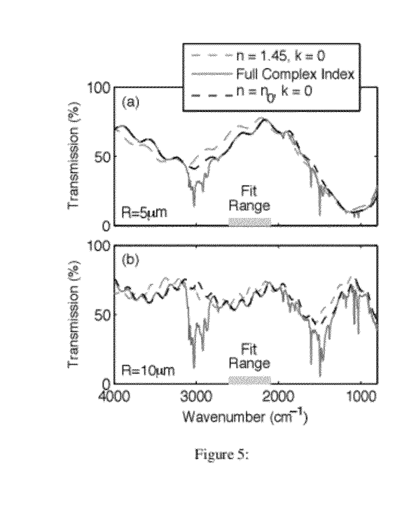

Most materials of interest exhibit a zero-absorbance zone between 2100 cm⁻¹ and 2600 cm⁻¹. Within this range the refractive index will be real and slowly varying (see FIG. 3). The value n₀ can be found by finding the real refractive index that best fits the data within this zero-absorbance band. Results of such a procedure are shown in FIG. 5. It can be seen that a constant-index model fits the data well in regions of no absorption. It should also be noted that the estimated values of n₀ agree well between the two fibers, and are also consistent with the true index plotted in FIG. 3.

The values of n₀ illustrated in FIG. 5 were found via a simple one-dimensional optimization procedure. The merit of any candidate value of n₀ can be evaluated by calculating the mean square error between the n( ν̅)=n₀, k( ν̅)=0 prediction and the data (in this case the simulated measurement from the toluene fiber). Minimizing this one-dimensional cost function gives the value of n₀. Here the golden section search algorithm was used for minimization over the range 1≦n₀≦1.8. The golden selection search algorithm is described by Kiefer et al., Proc. Amer. Math. Soc., 4, pp. 502-6 (1953), which is incorporated herein by reference. It should be noted that, in general, the goodness-of-fit will be a smooth continuous function, however local minima are to be expected. As the n₀ search space is one-dimensional and of limited range, convergence to local minima can be easily avoided. As illustrated by the n=1.45 plots in FIG. 5, the predicted data are sensitive to n₀, allowing a precise estimate to be made.

Recovering the Full Complex Index

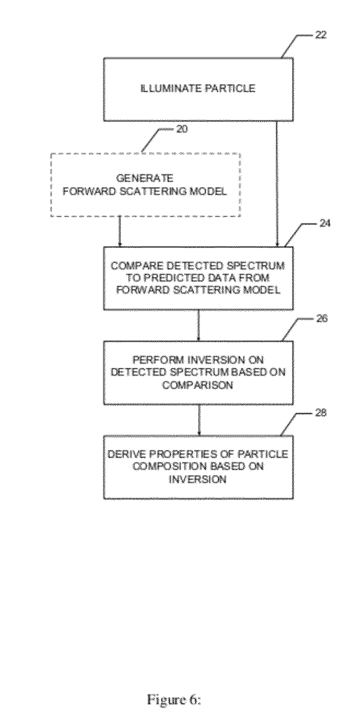

The ultimate goal of methods in accordance with the present invention is to find the complex refractive index of the particle from measurements, and thereby to characterize the composition of the particle. Steps corresponding to a preferred embodiment of the invention are described with reference to the flowchart shown in FIG. 6. After calibration of the optical system in the absence of the particle, the particle is illuminated (22) and a detected spectrum is compared (24) with a forward scatter model generated (20) on the basis of known or assumed geometrical attributes of the particle and known features of the optical system. An inversion is performed (26) on the detected spectrum based on the comparison of step (24). The result of the inversion is a spectrum corresponding to bulk properties of the composition of the particle, from which the composition itself, or other chemical properties may be derived (28) using standard spectroscopic techniques.

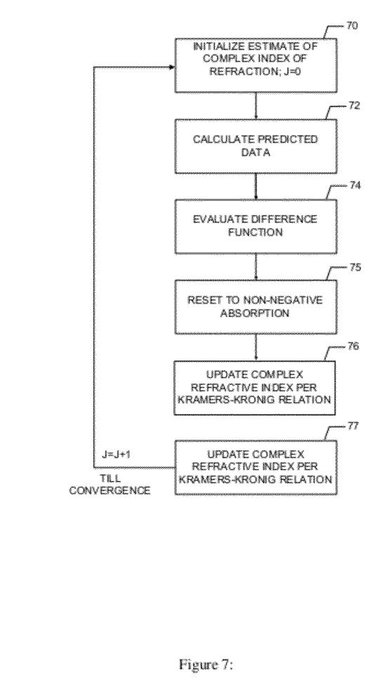

Steps in the inversion process are described with reference to the flowchart shown in FIG. 7. An initial estimate (70) of n₀ allows application of the forward model to calculate (72) a predicted complex index denoted by \hat{n}( ν̅)+i\hat{k}( ν̅) and the corresponding predicted intensity will be written as Î_{S}[ ν̅; \hat{n}( σ̅)]. The difference between the observed absorbance and the predicted absorbance, evaluated in step (74), can then be written as

$$E [ \overline{v} ; \hat{n} ( \overline{v} ) , \hat{k} ( \overline{v} ) ] = - {log}_{10} \{ \frac{{I}_{S} ( \overline{v} )}{{I}_{S} ( \overline{v} )} \} + {log}_{10} \{ \frac{{\hat{I}}_{S} [ \overline{v} ; \hat{n} ( \overline{v} ) , \hat{k} ( \overline{v} ) ]}{{I}_{S} ( \overline{v} )} \} . \qquad ( 24 )$$

Looking at FIG. 5, it appears that the data predicted for a real index of n₀ represent a baseline of the measurement. The error function E[ ν̅; n₀, 0] therefore represents a baseline corrected measurement. This sort of correction may be applied iteratively in an algorithm that reconstructs the complex refractive index of the fiber. Letting a bracketed superscript indicate the iteration number, one algorithm that may be employed in accordance with the present invention, and that is described with reference to FIG. 7, is the following:
Initialize Set the initial index estimate to \hat{n}⁽⁰⁾( ν̅)=N₀ and \hat{k}⁽⁰⁾( ν̅)=0. Initialize the iteration counter j=0. (70)
Predict Calculate the predicted data Î_{S}^{(j)}[ ν̅; \hat{n}^{(j)}( ν̅), \hat{k}^{(j)}(\hat{ν})]. (72)
Difference Evaluate the error function E^{(j)}[ ν̅; \hat{n}^{(j)}( ν̅), \hat{k}^{(j)}( ν̅)] using Eq. (24). (74)
Update 1a Update the imaginary part of the complex refractive index as

$${\hat{k}}^{( j + 1 )} ( \overline{v} ) = {\hat{k}}^{( j )} ( \overline{v} ) + \frac{γ}{\overline{v}} {E}^{( j )} [ \overline{v} ; {\hat{n}}^{( j )} ( \overline{v} ) , {\hat{k}}^{( j )} ( \overline{v} ) ] , \qquad ( 25 )$$

where γ is a positive constant.
Update 1b Set any negative values of \hat{k}^{(j)}(\hat{ν}) to zero. (75)
Update 2 Update the real part of the complex refractive index as

\hat{n}^{(j+1)}( ν̅)=n₀+K[\hat{k}^{(j+1)}( ν̅)], (26)

where K is a transformation based on the Kramers-Kronig relation. (76)
Iterate Increment the iteration counter, j←j+1, and either return to the Predict step or terminate if the algorithm has converged. (77)

The foregoing algorithm is initialized with the real refractive index calculated above. In each step a prediction of the data is made for the current estimate of the complex index. The absorbance corresponding to this prediction is compared to the measured absorbance and the difference is used to update the estimate of the imaginary index. As shown in Eq. (24), there is a ν̅ scaling relating the imaginary index and the absorbance. This scale factor appears in the update described in Eq. (25). The constant γ controls how much consecutive estimates of the imaginary index may differ. This constant should be positive to ensure that under-predicting the absorbance results in increasing the imaginary index. If γ is small, small updates will be made to the refractive index. This may result in slow convergence but also a more stable algorithm than for a large value of γ. A preferred value is

$$γ = \frac{{log}_{e} ( 10 )}{4 π ( 2 R )} . \qquad ( 27 )$$

This value is motivated by considering Eq. (22) and an ideal planar sample with a thickness equal to the maximum thickness of the fiber (2R). The absorbing volume for the fiber will be less than the absorbing volume for this hypothetical planar sample, ensuring that γ is conservatively set. However, the physically-motivated value of γ suggested in Eq. (27) will also be of approximately the correct order, leading to a rapidly converging algorithm.

Once the absorbance error has been used to update the imaginary index, any negative values of the result are set to zero. This is because a negative imaginary index is non-physical, corresponding to optical amplification. Once the estimate of the imaginary index has been updated, the real index can also be up-dated. Using an algorithm, as one described by Kuzmenko, Rev. Sci. Instrum., 76, 083108 (2005), incorporated herein by reference, and based on the Kramers-Kronig relation, the real index can be calculated from the imaginary index. Note that the Kramers-Kronig relation does not constrain the constant component of the real index, and so the value n₀ is enforced explicitly.

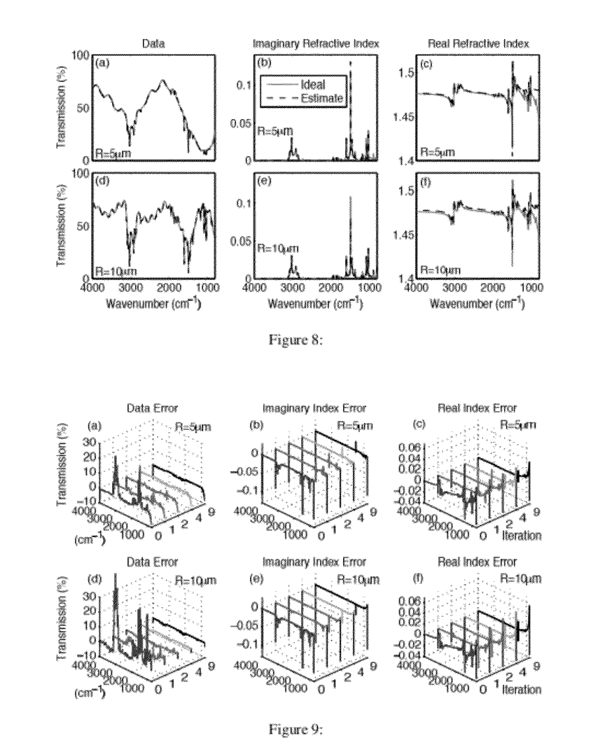

The algorithm described above was applied to the data seen in FIG. 4, which were calculated on an axis with a sample spacing of 2 cm⁻¹. The results are shown in FIG. 8. It can be seen that the algorithm results in a refractive index estimate giving a close match between the measurement and the predicted data. The estimate of the index mostly follows the true value, but with some noteworthy departures.

The differences between the estimated quantities and the true underlying values are shown in FIG. 9. It can be seen that the algorithm converges rapidly to a small error profile. The final mismatch between the prediction and the data [illustrated in plots (a) and (d) of FIG. 9] is small, indicating that a feasible estimate of the refractive index has been found. However, it can also be seen that the estimated index does differ from the true value in a few key areas—most notably near the low-wavenumber edge of the axis and at the strongest absorption peak.

The departure near the edge of the axis can be explained by the non-local nature of the Kramers-Kronig relation. It is well known that each value of the real index estimated by a Kramers-Kronig procedure is affected by a significant region of the spectral profile of the imaginary index. This results in difficulty estimating the real index near the edge of the measurement bandwidth, as contributing imaginary-index regions are unobserved. This problem is borne-out in the example shown here, as a strong absorption band below the measurement bandwidth contributes to the real-index profile at the low-wavenumber region of the measurement. This kind of error may be corrected if prior knowledge of the refractive index outside the measurement band is available. It should also be noted that this error is less significant in the estimate of the imaginary index, which is all that is typically of interest in absorption spectroscopy applications.

The estimate of the imaginary index also contains a significant error at the strong absorption peak at ν̅=1496 cm⁻¹. High absorption peaks are necessarily associated with large changes in the real refractive index, which will in turn correspond to rapid changes in the scattering from the fiber. Consequently, at strong peaks it may be difficult to distinguish strong scattering from strong absorption. However, the algorithm does consistently distinguish these effects at lower absorption levels. It is also worth noting that the sign of the error at ν̅=1496 cm⁻¹ differs between the 5 μm-radius and the 10 μm-radius fibers.

For close-packed bundles of fibers in which the fibers cannot be considered isolated, a generalization of the methods described above may be applied by extending the framework of the forward model described herein with a T-matrix approach described by Mischenko et al., J. Quant. Spectrosc. Radiat. Transfer, 55, pp. 535-75 (1996).

A method for recovering the optical properties of the fiber (as characterized by the complex refractive index) from focused spectroscopic measurements was also developed. That is, we have presented a method of solving the inverse problem. This inverse solution makes possible geometry-independent spectroscopic characterization of optical fibers. In our implementation, a simplification was introduced in that the position and size of the fiber were known independently. These parameters could instead be jointly estimated along with the bulk spectral response similar to the approach taken in US Published Patent Application No. 2010/0067005 in the analysis of nanoparticles. With a diversity of polarization states incident and polarization-sensitive measurement, it is possible to include in this approach the estimation of birefringent susceptibilities.

As indicated above, the methods described herein may be applied to particles of any shape. Moreover, a library of shapes may be provided, with forward models stored for each shape, whereby a shape may be selected by a user for a particular application. Additionally, various parameters characterizing the geometry of the particle may be solved for, by numerical methods known in the art of optimization.

The present invention may be embodied in any number of instrument modalities. In alternative embodiments, the disclosed methods for extracting material spectroscopic properties may be implemented as a computer program product for use with a computer system. Such implementations may include a series of computer instructions fixed either on a non-transient tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product), or as a non-transitory computer readable medium including computer readable program code.

Embodiments of the invention described herein are presented by way of example only, and other variations and modifications are within the scope of the present invention as defined in any appended claims.

We claim:

1. A method for extracting bulk spectroscopic properties of a particle, the particle characterized by a complex refractive index having a real and an imaginary part, the method comprising:
a. building a forward model of an optical field focused on, and interacting with, the particle, the forward model parameterized in terms of at least one geometrical characteristic of the particle;
b. illuminating the particle with an incident optical field having a spectral range;
c. detecting at least one of a transmitted and scattered optical field in a far-field zone as a function of wavenumber to obtain a measured spectrum; and
d. inverting the measured spectrum to recover the imaginary part of the complex refractive index of the particle.

2. A method in accordance with claim 1, wherein the particle is a filament.

3. A method in accordance with claim 1, wherein the at least one geometrical characteristic includes a radius of a filamentary material.

4. A method in accordance with claim 1, wherein the particle is a filament.

5. A method in accordance with claim 1, wherein the particle is a sphere.

6. A method in accordance with claim 1, wherein the particle is an oblate spheroid.

7. A method in accordance with claim 1, wherein the particle is a prolate spheroid.

8. A method in accordance with claim 1, wherein inverting includes:
a. assuming an initial real index;
b. calculating an absorption spectrum;
c. evaluating a difference between the calculated absorption spectrum and the measured spectrum;
d. applying the Kramers-Kronig relation to obtain an updated real index; and
e. iterating steps (ii.) through (iv.) to convergence.

9. A method in accordance with claim 1, further comprising: performing an initial calibration in absence of the particle.

10. A method in accordance with claim 1, further comprising: determining material composition of the particle based on a spectrum of the complex refractive index of the particle.

11. A non-transitory computer readable medium for use on a computer system for extracting bulk spectroscopic properties of a particle, the non-transitory computer readable medium having computer-readable program code thereon, the computer readable program code comprising:
a. a computer code module for building a forward model of an optical field focused on, and interacting with, the particle, the forward model parameterized in terms of at least one geometrical characteristic of the particle;
b. a computer code module for receiving a detector signal as a function of wavenumber to obtain a measured spectrum of the particle; and
c. a computer code module for inverting the measured spectrum of the particle to recover the imaginary part of the complex refractive index of the particle.

12. A non-transitory computer medium in accordance with claim 11, wherein the particle is a filament.

13. A non-transitory computer medium in accordance with claim 11, wherein the particle is a sphere.

14. A non-transitory computer medium in accordance with claim 11, wherein the particle is an oblate spheroid.

15. A non-transitory computer medium in accordance with claim 11, wherein the particle is a prolate spheroid.

16. A non-transitory computer medium in accordance with claim 11, wherein the at least one geometrical characteristic includes a radius of a filamentary material.

17. A non-transitory computer medium in accordance with claim 11, wherein the computer code module for inverting the measured spectrum includes:
a. a computer module for calculating an absorption spectrum based upon the forward model and an initial real index;
c. a computer module for evaluating a difference between the calculated absorption spectrum and the measured spectrum; and
d. a computer module for applying the Kramers-Kronig relation to obtain an updated real index for subsequent reapplication of the forward model.
